(19) United States
(12) Patent Application Publication
(10) Pub. No.: US 2015/0188876 A1
(43) Pub. Date: Jul. 2, 2015

(54) CALENDARING SYSTEMS AND METHODS

(71) Applicant: Runaway Plan, LLC, Washington, DC (US)

(72) Inventor: Jerome David Jackson, Falls Church, VA (US)

(21) Appl. No.: 14/450,499

(22) Filed: Aug. 4, 2014

Related U.S. Application Data
(60) Provisional application No. 61/950,189, filed on Mar. 9, 2014.
(60) Provisional application No. 61/921,158, filed on Dec. 27, 2013.

(51) Int. Cl. H04L 12/58

(52) U.S. Cl. CPC H04L 51/36; H04L 51/22; H04L 51/02

(57) ABSTRACT

Various types and implementations of calendaring systems and methods employ electronic mail.

### BACKGROUND OF THE INVENTION

This Application claims the benefit of U.S. Provisional Patent Application 61/921,158 filed 27 Dec. 2013 of Jerome David Jackson for CALENDARING SYSTEMS AND METHODS, the contents of which are herein incorporated by reference. This Application claims the benefit of U.S. Provisional Patent Application 61/950,189 filed 9 Mar. 2014 of Jerome David Jackson for CALENDARING SYSTEMS AND METHODS, the contents of which are herein incorporated by reference.

### FIELD OF THE INVENTION

This invention relates generally to systems and methods for memorizing tasks to be done and, more particularly, to systems and methods of generating entries on calendars.

### SUMMARY OF THE INVENTION

According to an aspect of the present invention, there is system configured to manage a calendar. The system includes first circuitry including a first set of computer instructions, activated without manual intervention, configured to receive an electronic mail (email) message containing an event date and an event type, search for the event type in a database and, if the event type is found, generate a set of tasks to be performed. Each task has a respective date, one of the respective dates being different from the date of the event type, without manual intervention. The system also includes a memory configured to store the set of tasks; and second circuitry including a second set of computer instructions, configured to subsequently receive a message from a user computer system and, responsive to the message, send the stored set of tasks to the user computer system.

According to another aspect of the present invention, there is a method of managing a calendar. The method includes receiving an email message containing an event date and event type, by executing a first set of computer instructions; searching for the event type in a database and, if the event type is found, generating a set of tasks to be performed, each task having a respective date, one of the respective dates being different from the date of the event type, without manual intervention; storing the set of tasks; and subsequently, responsive to receiving a message from a user computer system, sending the stored set of tasks to the user computer system, by executing a second set of computer instructions.

According to yet another aspect of the present invention, there is a system configured to manage a calendar. The system includes means for receiving an email message containing an event date and an event type; means, activated by reception of the email by the means for receiving, for searching for the event type in a database and, if the event type is found, generating a set of tasks to be performed, each task having a respective date, one of the respective dates being different from the date of the event type, without manual intervention; and means for receiving a message from a user computer system and, responsive to the message, sending the stored set of tasks to the user computer system.

According to yet another aspect of the present invention, there is a method of managing a calendar by operating with a server. The method includes establishing an account with the server, by supplying a user name and user password; and while logged in with the user name and user password, sending a message to the server, to cause the server to reply with the set of stored tasks.

According to yet another aspect of the present invention, there is a method of managing a calendar by operating with a first system. The method includes establishing a first account with the first system, by supplying a first user name and first user password; and providing a second system with an email user name that will be used by the first system to receive a first message, for the first account, from the second system.

### BRIEF DESCRIPTION OF THE DRAWINGS

References are made, in the following text, to the accompanying drawings, in which:

FIG. 1 shows a system operating with an exemplary embodiment of the present invention.

FIG. 2 is a relatively abstract functional diagram showing a processing performed by an exemplary system.

FIG. 3 shows some exemplary data structures.

FIG. 4 shows details exemplary message.

FIG. 5 shows an aspect of an exemplary computer program.

FIG. 6 is a flow chart describing an exemplary processing.

FIG. 7 shows a user display responding to a signal generated in an exemplary system.

FIG. 8 is a diagram emphasizing some hardware and software to effect an exemplary implementation.

FIG. 9 shows the user display responding to another signal.

FIG. 10 shows the user display.

FIG. 11 shows the user display responding to yet another signal.

FIG. 12 is a diagram emphasizing aspects of another exemplary system.

FIG. 13 is a diagram emphasizing other aspects of another exemplary system.

FIG. 14 is diagram of an exemplary user workstation.

FIGS. 15A and 15B is a flow chart showing processing performed by an exemplary system.

FIG. 16 shows a display generated by a notification system being configured to operate with an exemplary system and a first computer system associated with a first user.

FIG. 17 shows a display generated by a notification system being configured to operate with an exemplary system and a second computer system associated with a second user.

The accompanying drawings which are incorporated in and which constitute a part of this specification, illustrate embodiments of the invention and, together with the description, explain the principles of the invention, and additional advantages thereof. Certain drawings are not necessarily to scale, and certain features may be shown larger than relative actual size to facilitate a more clear description of those features. Throughout the drawings, corresponding elements are labeled with corresponding reference numbers.

### DETAILED DESCRIPTION OF EXEMPLARY EMBODIMENTS

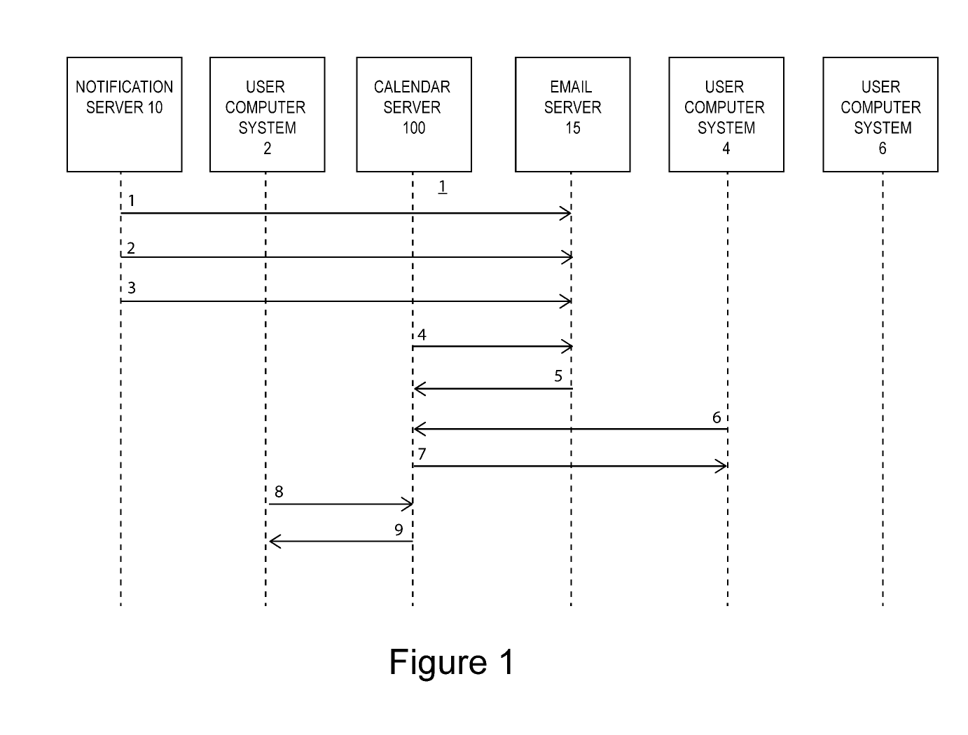

FIG. 1 shows system 1 according to an exemplary embodiment of the present invention. Notification server 10 sends an email message 1 to the depicted email server, using the Simple Mail Transfer Protocol (SMTP), for example. Notification server 10 sends an email message 2 to the email server 15. Notification server 10 sends an email message 3 to the email server 15.

From time to time, calendar server 100 sends a message such as message 4, in IMAP or POP protocol for example, to the email server 15. In response, the email server 15 sends a message such as message 5, containing the email messages 1, 2, and 3.

Server 100 sends a common user name and common password, to email server 15, in order to access messages 1, 2, and 3.

Responsive to email message 1, calendar server 100 makes a calendar entry in database.

In response to a user command from a mouse or keyboard, for example, a browser running in user computer system 2 sends a Hypertext Transfer Protocol (HTTP) message 8 to calendar server 100.

In response to receiving a HTTP message 8 from system 2, calendar server 100 causes system 2 to display a calendar, including a date calendared by server 100 in response to email message 1, by generating an HTML page and sending the HTML page to system 2, via HTTP message 9.

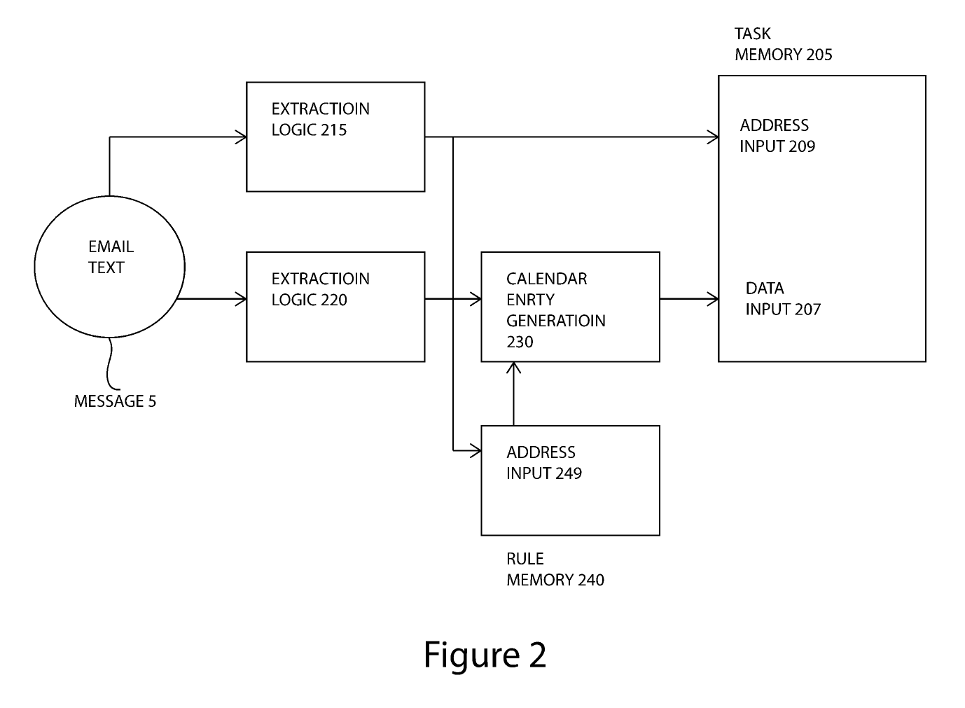

FIG. 2 is a relatively abstract functional diagram showing a processing performed by circuitry in calendar server 100. In this Patent Application, the word circuitry encompasses dedicated hardware, and/or programmable hardware, such as a central processing unit (CPU) or reconfigurable logic array, in combination with programming data, such as sequentially fetched CPU instructions or programming data for a reconfigurable array. Thus, circuitry encompasses, for example, a general-purpose electronic processor programmed with software, acting to carry out a described function.

Task memory 205 is essentially a set of calendars. The data (calendar), corresponding to a particular address, includes a textual description of tasks to be performed and dates date on which the task are to be performed.

The address input 209 is responsive to a user name. Thus, calendar server 100 maintains a respective calendar for each of a plurality of users.

Extraction model 215 generates the user identification, by reading text of the email messages. More specifically, extraction logic 215 determines a user identification by examining the “to” (destination) field of the email message.

Extraction module 220 generates an event identification and event date.

Task generation module 230 generates a calendar entry and writes the calendar entry to data input 207 of task memory 205.

The address input 249, of rule memory 240, is responsive to a user identification. Thus, calendar server 100 maintains a respective rule set for each of the plurality of users.

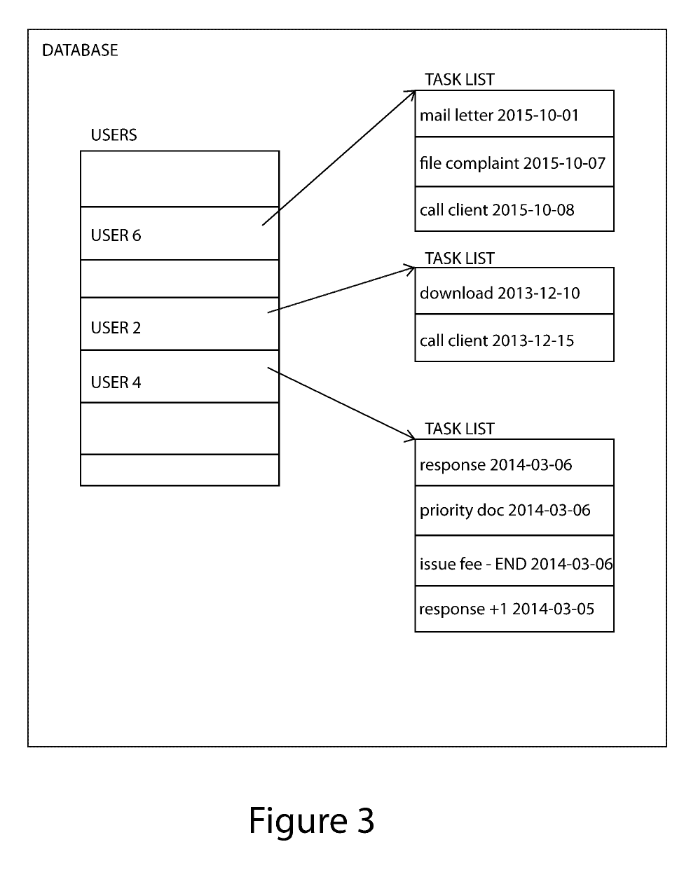

FIG. 3 shows data structures stored in a magnetic disk memory in calendar server 100. Each user has a respective list of tasks, which is essentially a calendar.

In the data structures shown in the figures, lines represent a reference, such as a pointer, between one element and another. These references are not necessarily direct memory address pointers. Instead, more generally, each reference is a data entity, stored in association with one (referencing) element, that enables a processor to find a related (referenced) element. To physically address the referenced element, the processor may subject the reference to various translations or mappings. In the case of the reference from the users to the respective task list, the referencing can implemented with a key structure implemented by a key structure in which a key identifying a user is a direct key to a key or a certain test on a certain date.

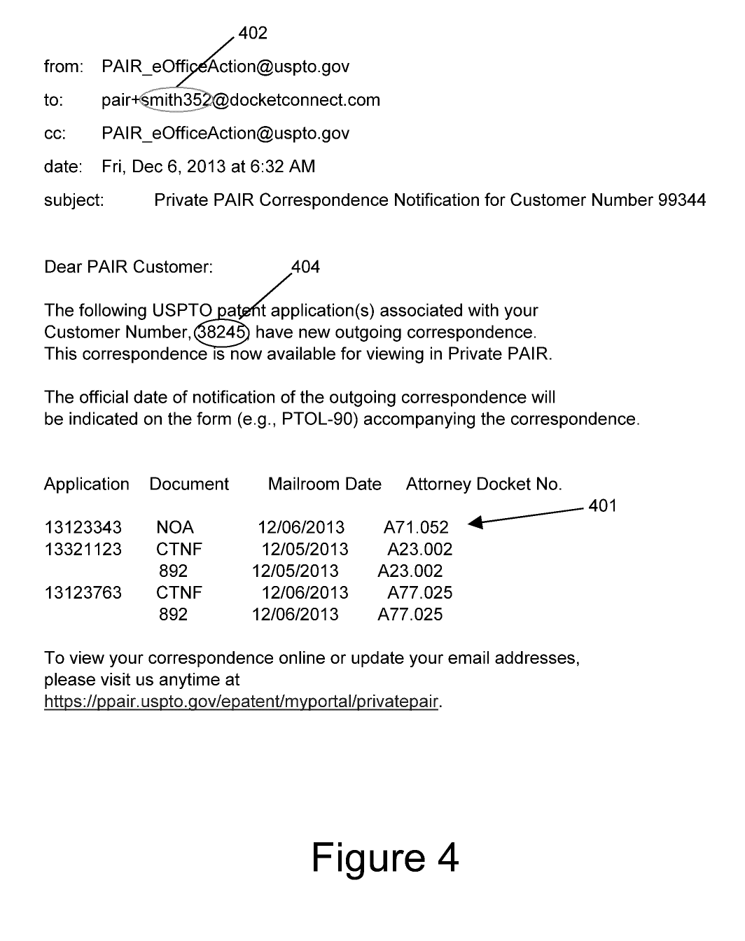

FIG. 4 shows email message 1 in more detail.

Each of the lines 401 represents a respective event. Calendar server 100 processes each line and generates a set of tasks for the line. A task set can be empty (null), meaning that there are no tasks to be calendared for a particular event. A task set can be non-null, meaning that 1 or a plurality of tasks correspond to the event line.

In FIG. 4, the column under “Document” contains an indication of the event. The column under “Mailroom Data” contains respective dates of the event. The task set can have dates that are different from the date of the event.

The column under “Attorney Docket No.” Identifies a particular matter, such as a particular patent application for a particular client.

As shown at 402, the destination email address contains an indication of the user.

Thus, email message 1 includes a set of patent application numbers (13123343, 13321123, 13123763), codes for documents (NOA, CTNF, 892), dates corresponding to the documents, attorney docket identifiers, a Customer Number (38245), and a string designating an email address (pair+smith352@docketconnect.com).

Email message 2 includes a set of patent application numbers (14123745, 12763123) different from the set of patent application numbers in email message 1. Email message 2 also includes codes for documents (CTRS, 1449), dates corresponding to the documents, attorney docket identifiers, a Customer Number (27340) different from the customer number in email message 1, and a string designating an email address (pair+jones947@docketconnect.com).

Email message 3 includes a set of patent application numbers (12753261) different from the set of patent application numbers in email message 1, and different from the set of patent application numbers in email message 2. Email message 2 also includes a code for a document (CTEQ), a date corresponding to the document, an attorney docket identifier, a Customer Number (41017) different from the customer number in email message 2 and different from the customer number in email message 1, and a string designating an email address (pair+green123@docketconnect.com).

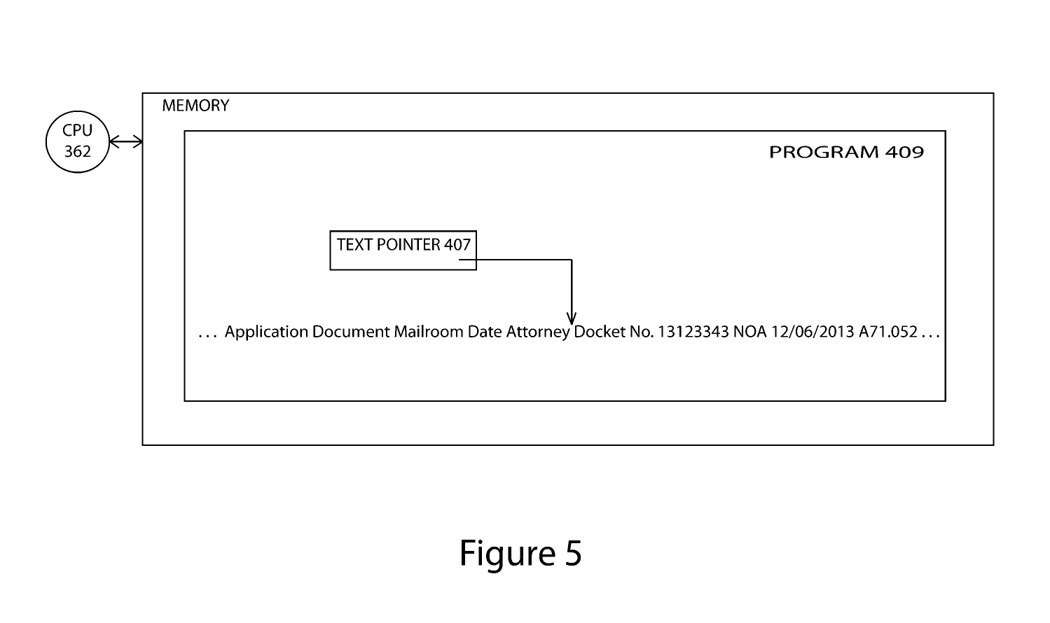

FIG. 5 shows an aspect of program 409 executed by central processing unit (CPU) 362. Program 409 parses email text by recognizing certain delimiters. Program 409 increments text pointer 407 as parsing progresses. At the time depicted in FIG. 5, program 409 is searching for the string “Attorney Docket No.”. The processing of program 409 could be in, for example, implementation of the string method “find’ of the Python programming language.

The processing of FIG. 5, thus enable server 100 to select or isolate the lines 401 shown in FIG. 4.

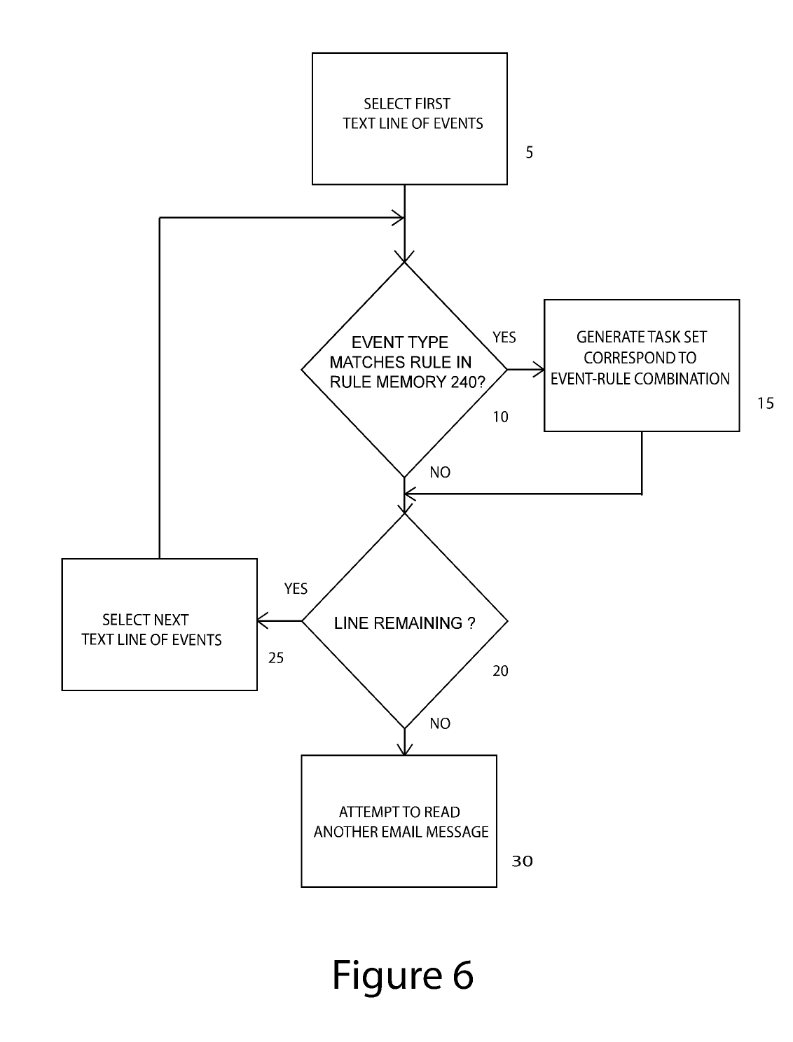

After server 100 performs the processing of FIG. 5, server 100 performs the processing of FIG. 6. CPU 362 selects the first text line of lines 401. CPU 362 determines whether the current text line of events matches a rule in rule memory 240. If the current line does match, CPU 362 generates a task set and, if non-null, writes the task set into task memory 205.

CPU 362 determines whether there are text line of events remaining. If there are text line of events remaining, CPU 462 selects the next text line of events (step 25) and resumes processing at step 10.

If step 20 determines there are no text line of events remaining, CPU 362 attempts to read another message.

To prepare for the processing of steps 5 and 25, server 100, for example, executes the Python string “split” method on the text 401 isolated by the processing of FIG. 5.

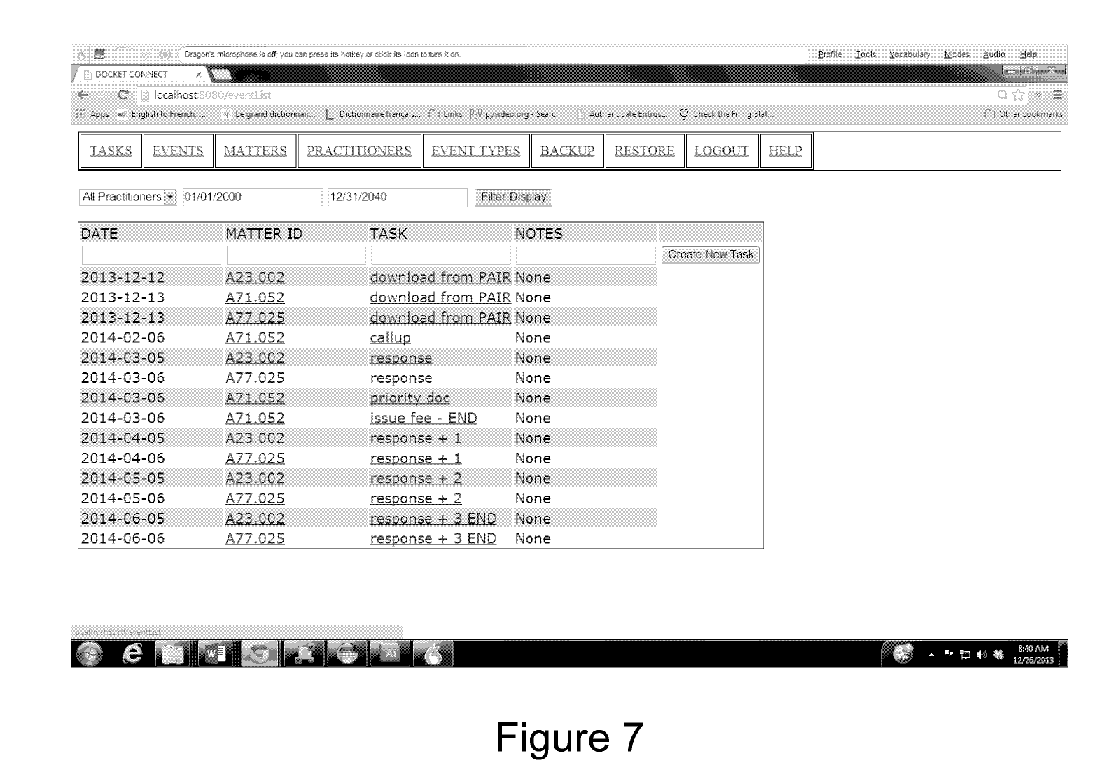

In response to the message 7 sent by server 100, a browser running on computer system 2 generates a user display shown in FIG. 7.

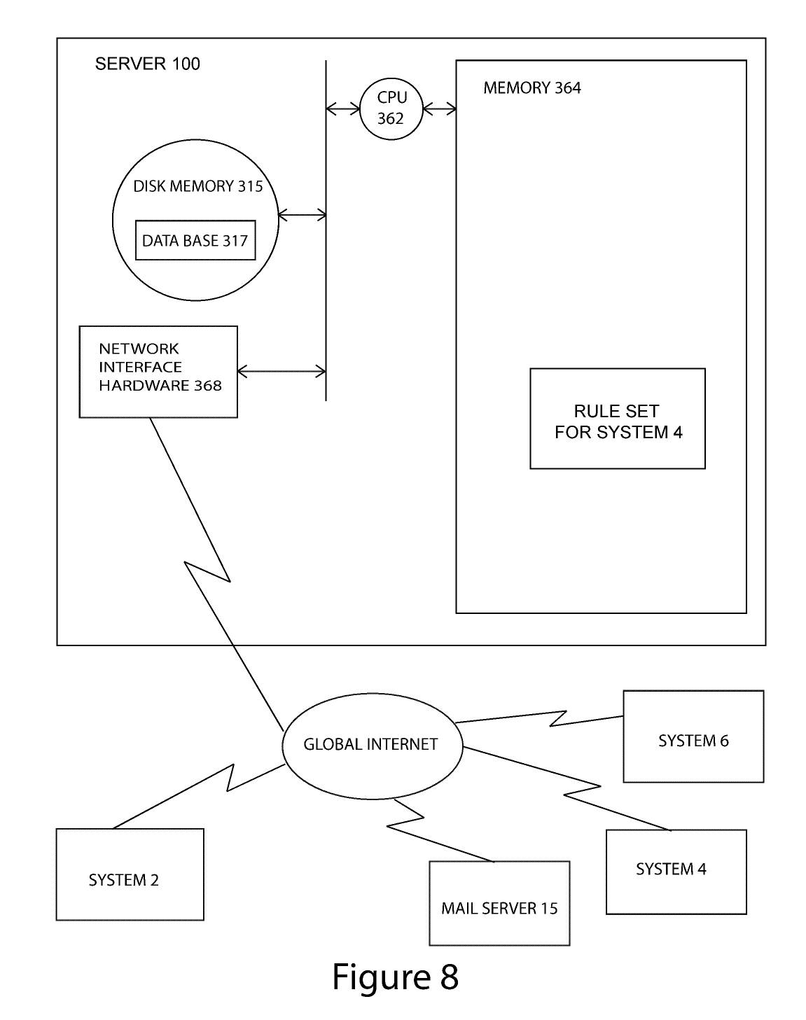

As shown in FIG. 8, the calendar server 100 includes a central processing unit 362, an electronic memory 364, and network interface hardware 368.

Processor 362 executes various programs stored in memory 364.

Memory 364 stores a respective rule set for each of user computer systems 2, 4, 6, and 8. Memory 364 stores a respective task list (calendar) for each of user computer systems 2, 4, 6, and 8.

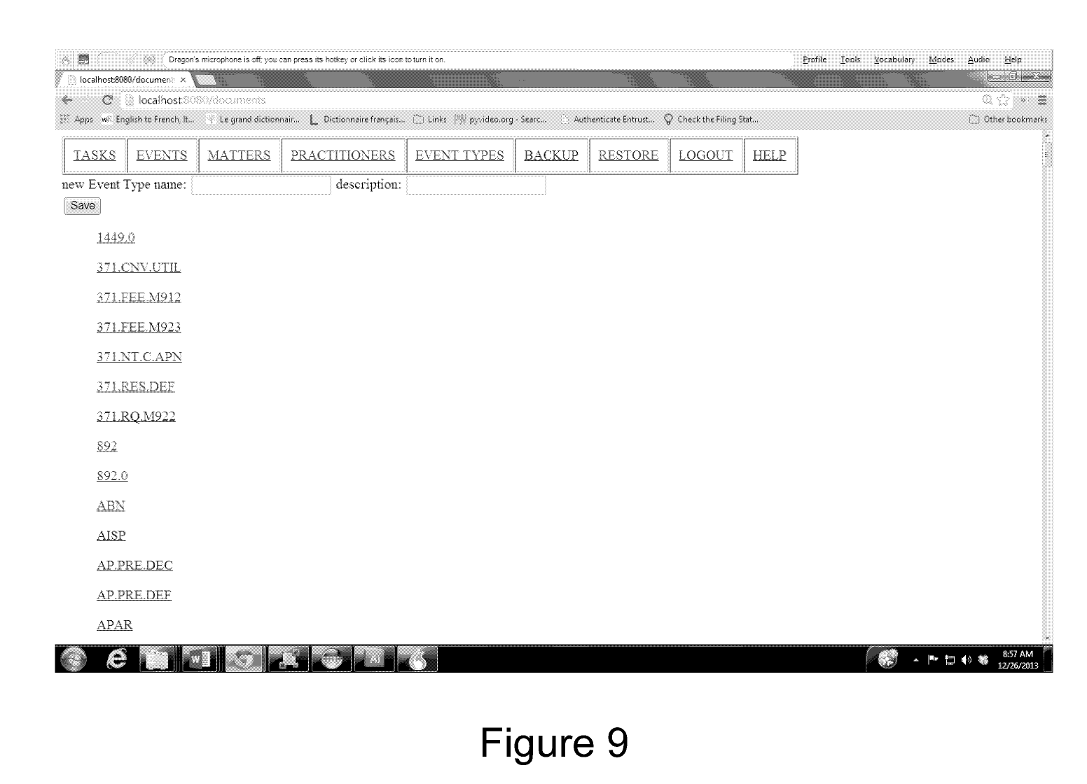

While using the browser in system 4 and mouse clicking the EVENT TYPES, shown at the top of the FIG. 7, calendar server 100 sends a HTML page shown in FIG. 9 to the browser.

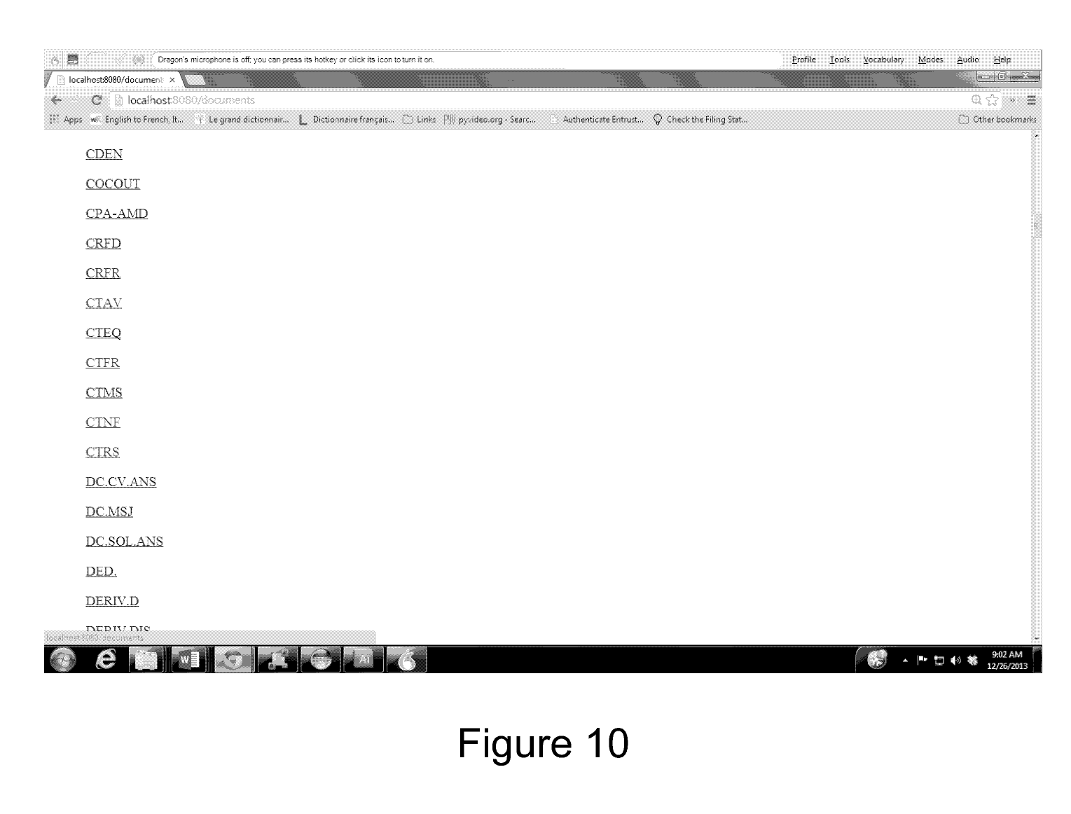

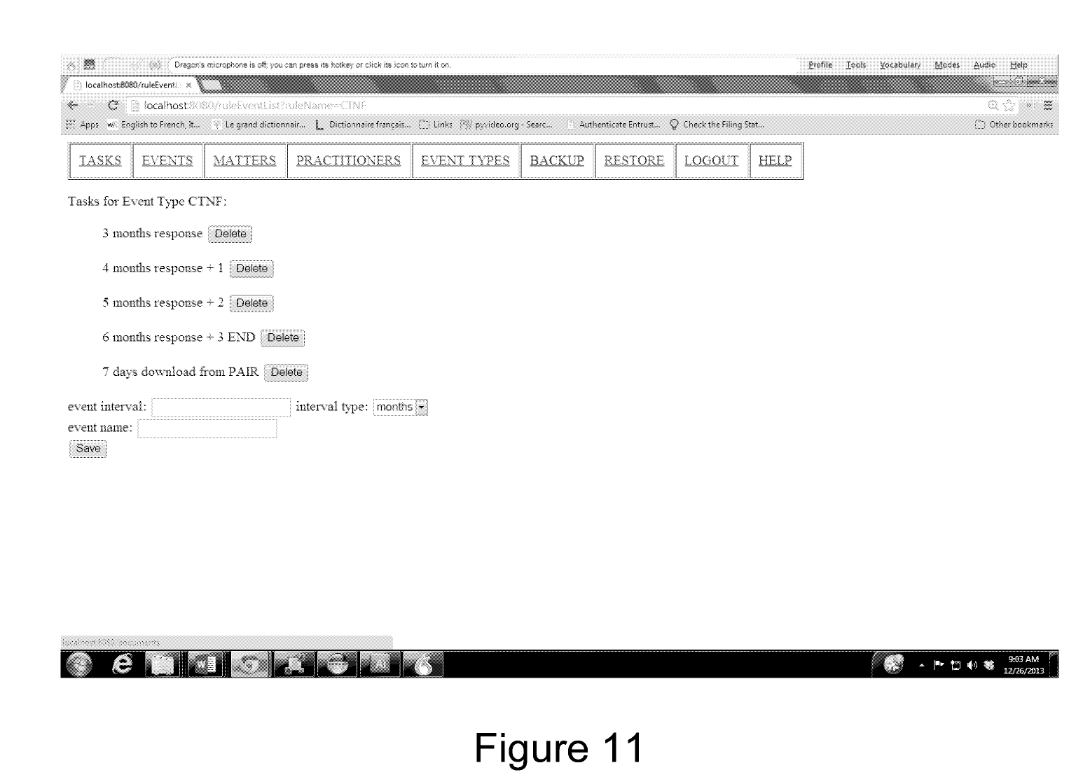

FIG. 10 shows the HTML page of FIG. 9 after scrolling down by the user. If the user clicks on the CTNF and that link shown in FIG. 10, the browser sends a message to server 100, causing server 100 to send an HTML page to the browser, which is shown in FIG. 11. As shown in FIG. 11 there are a rules specifying a task set for event of the event type CTNF. The user can add to the task set using the interval name, and interval type, event name, and save button.

In response to a user command from a mouse or keyboard, for example, a browser running in system 2 sends a Hypertext Transfer Protocol (HTTP) message 8 to calendar server 100

In response to receiving a HTTP message 8 from system 2, calendar server 100 causes system 2 to display a calendar, including a date calendared by server 100 in response to message 1, by generating an HTML page to system 2, via HTTP message 9. System 100 generates the HTML page for system 2 by using the task list associated with system 2 (see FIG. 3 and accompanying text).

In response to a user command from a mouse or keyboard, for example, a browser running in user computer system 4 sends a Hypertext Transfer Protocol (HTTP) message 6 to calendar server 100.

In response to receiving a HTTP message 6 from system 4, calendar server 100 causes system 4 to display a calendar, including a date calendared by server 100 in response to email message 2, by generating an HTML page and sending the an HTML page to system 4, via HTTP message 7.

A date generated by and calendared by server 100, in response to email message 1, is not in email message 1. A date generated by and calendared by server 100, in response to email message 2, is not in email message 2. A date generated by and calendared by server 100, in response to email message 3, is not in email message 3.

Calendar server 100, notification server 10, system 2, system 4, system 6 and user 8 are non-affiliated with each other, meaning that they are not affiliates with respect to each other. In this Patent Application, concerns are affiliates of each other when one concern controls or has the power to control the other, or a third party or parties controls or has the power to control both. Power to control is described in Section 121 of the U.S. regulations of the Small Business Administration.

Notification server 10 could be, for example, operated by an entity such as the U.S. Patent and Trademark Office (USPTO), to implement the USPTO e-office action program, which notifies applicants, or their legal representatives, via email, that a new USPTO communication is available for viewing and downloading in a database operated by the USPTO.

The users of systems 2, 4, and 6 each have a respective notification server 10 identification stored by notification server 10. Notification server 10 stores “Customer Cumber 38245” as an identification of a user of system 2. Notification server 10 stores “Customer Cumber 27340” as an identification of a user of system 4. Notification server 10 stores “Customer Cumber 41017” as an identification of a user of system 6.

The computer system 2 is typically separated from calendar server 100 by more than 1 kilometer. The calendar server 100 is typically separated from the email server 15 by more than 1 kilometer. The email server 15 is typically separated from computer system 2 by more than 1 kilometer.

In an alternative embodiment, different person could access a common system account with different privileges. Certain tasks can only be deleted by the person with a certain privilege. Thus, an event type could have a set of tasks, including a verify task for example, so that a clerical person could enter the event, thereby calendaring a set of tasks, but only a supervisor with account privileges could subsequently delete the verify task, after the supervisor herself verifies the correctness of the event type, event date, etc.

In another alternate embodiment, the calendar server detects when an event message has not been received for a particular user from the notification server for a certain amount of time and, upon this detection, issues a warning email to the user. Thus, the user is alerted to the possibility of an email outage that may have prevented emails from the notification server from being successively sent and received by the calendar server. In this case, the user would then manually inspect the USPTO database associated with his account.

The processing described above can be implemented with a Google App Engine front end or back end, or with more dedicated, less distributed, circuitry.

### MORE DETAILED DESCRIPTION OF EXEMPLARY SYSTEMS

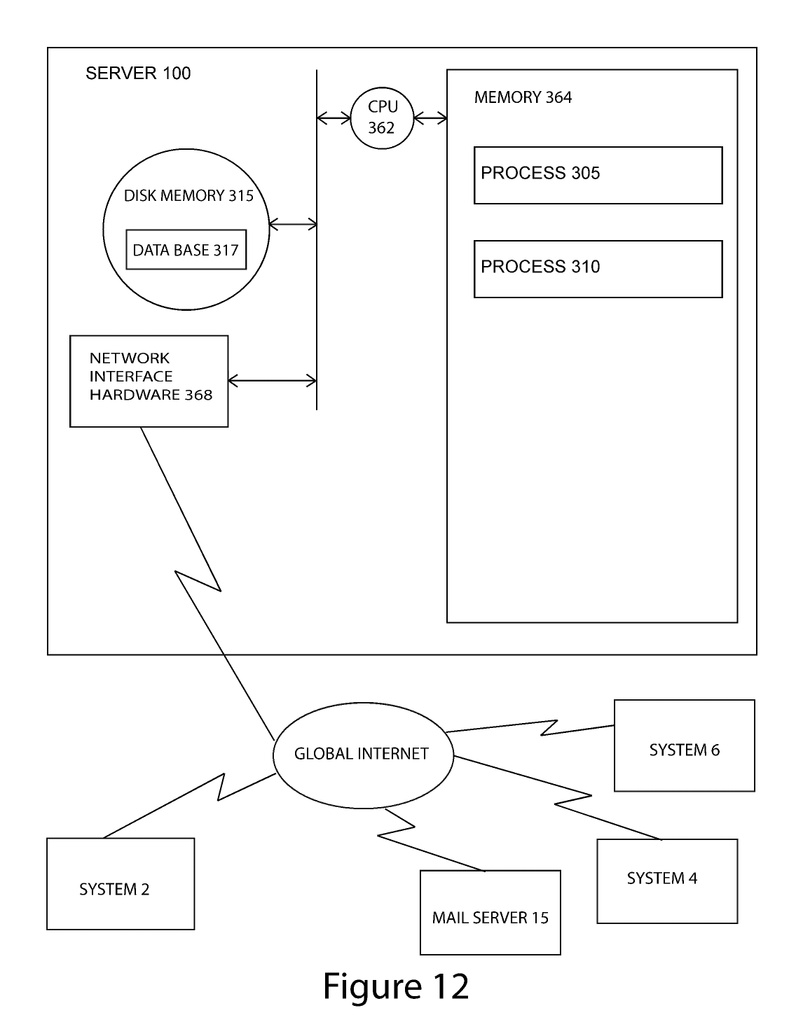

FIG. 12 is a diagram emphasizing other aspects of server 100.

CPU 362 executes software instructions in process 305 to effect processing of HTTP get requests, to cause server 100 to send calendar entry data to user computer system 2. The software instructions of process 305 reside on disk memory 315 and are paged into random access memory 364 on demand, as is known in the art.

CPU 362 executes software instructions in process 310 to read email messages from notification server 10. The software instructions of process 310 reside on disk memory 315 and are paged into random access memory 364 on demand.

CPU 362 executes the software instructions of process 305 and process 310, in a time-sharing fashion, as dictated by a scheduler that may be part of a standard operating system.

Each of process 305 and 310 has a respective address space.

A scheduler governing server 100 activates process 310 on a time basis, once per hour or per day for example. In response to activation, process 310 sends a message such as message 4, in IMAP or POP protocol for example, to email server 15. In response, the email server sends a message such as message 5, containing the email messages 1, 2, and 3.

Server 100 receives the email messages 1, 2, and 3 via a signal path that does not include (excludes, bypasses) the user computer systems 2, 4, and 6.

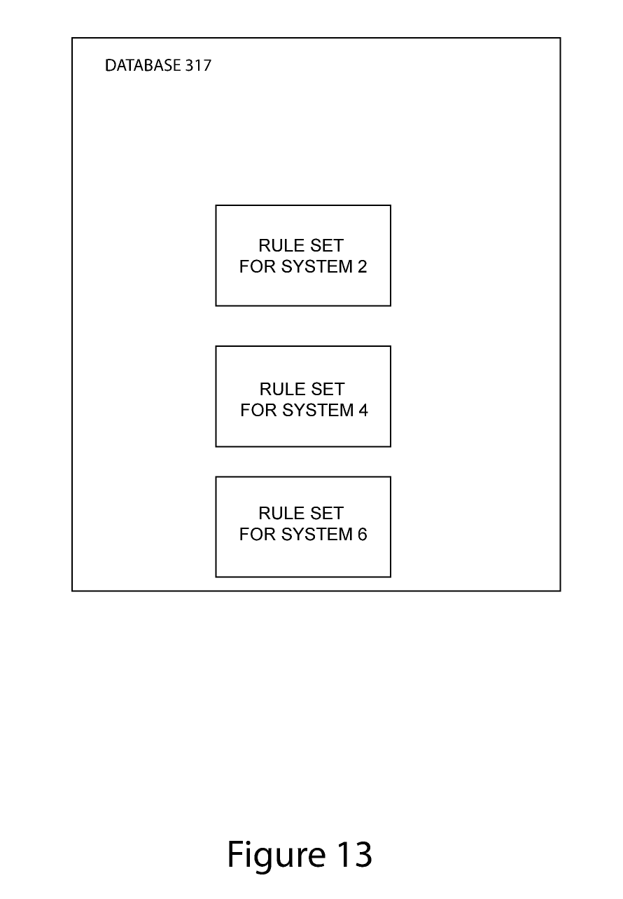

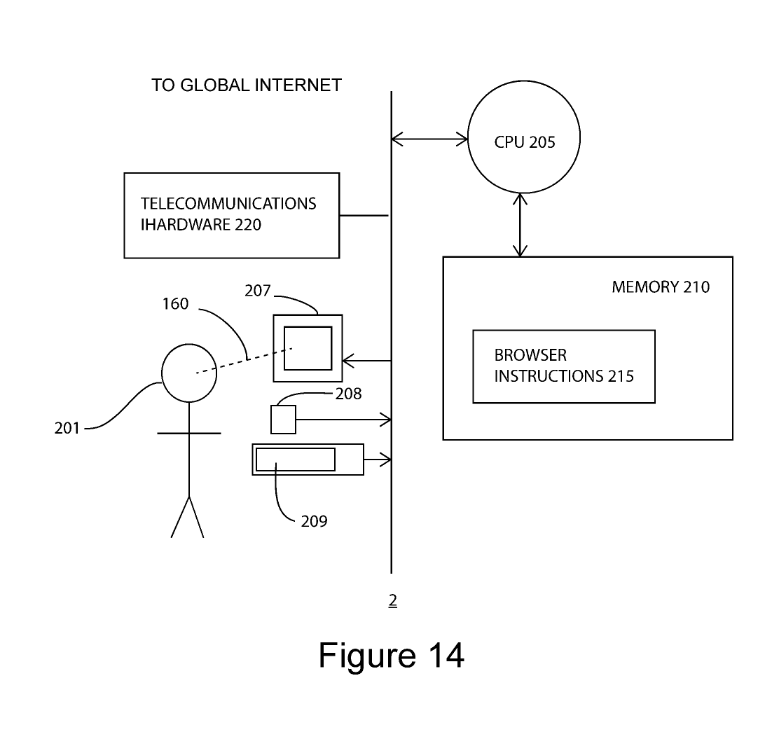

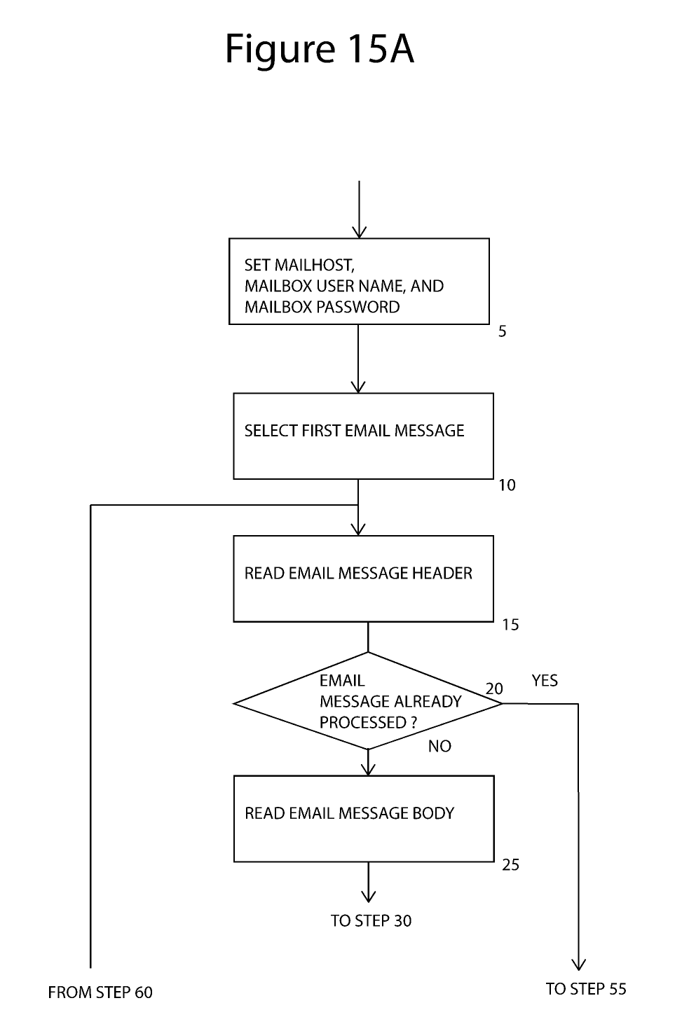

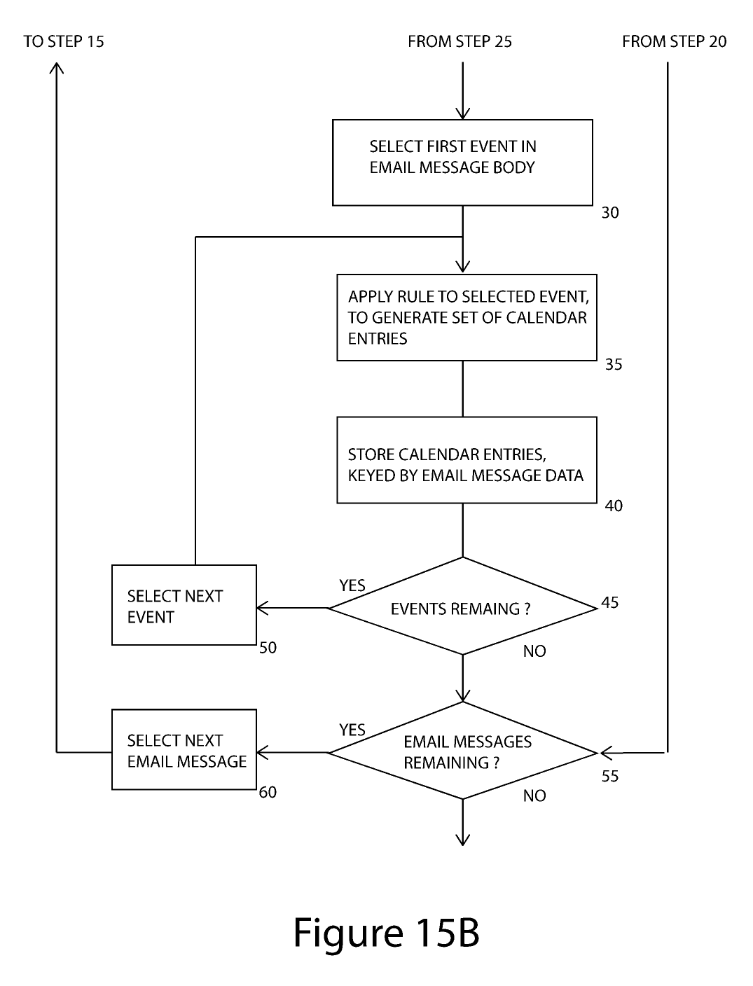

FIGS. 13A and 13B show a processing performed by process 310 in more detail. CPU 362 selects identification information for a mailbox (for example, mailsite=“pop.gmail.com”; mail_user_ID=“recent:pair@docketconnect.com”; and mail_password=“frontroyal77”) (step 5). CPU 362 selects the first email message in the inbox (step 5).

CPU 362 reads the header of the current email message (step 10). If the database of server 100 indicates that the header is of an email that has already been processed, (step 20), processing flows to step 55. If the database of server 100 indicates that the header is of an email that has not yet been processed, (step 20), processing flows to step 25.

CPU 362 reads the body of the current email message (step 25) and selects the first event in the email message body (step 30). Step 30 could be performed using the processing described in connection with FIG. 5 above.

CPU 362 applies a rule to the current event, to generate a set of calendar entries, where the date(s) of the calendar entries depends on the date of the event, but can be different from the date of the event. (Step 35).

CPU 362 stores the calendar entries generated by step 35, using a key (or addressing) value derived from the current email message. (Step 40).

CPU 362 determines whether there are events remaining in the current email message body (step 45). If there are events remaining, CPU 362 selects the next event (step 50) and resumes processing at step 35.

CPU 362 determines whether there are email messages remaining in the inbox selected in step 5 (step 55). If there are email messages remaining, CPU 362 selects the next email message (step 60) and resumes processing at step 15.

In summary CPU 362 and process instructions 310 constitute a type of circuitry that acts to receive an electronic mail message containing an event date and an event type, such as type CTNF. CPU 362, executing instructions 310, acts to locate the event type in rule memory 240 (database 317) generate a set of tasks to be performed, each task having a respective date, one of the respective dates being different from the date of the event type. CPU 362 executes instructions 310 independent of any direction from the user computer system.

FIG. 12 shows user computer system 2 in more detail. Computer system 2 is associated with user 201. System 2 includes CPU 205, flat panel display 207, mouse input device 208, keyboard 209, memory system 210 for storing programs and data, and telecommunications hardware 220. Memory system 210 includes random access memory (RAM) and disk memory. User computer system 2 may include only a single workstation, or multiple workstations communicating through a common local area network, or wider area intranet.

Display 207 is an output device and mouse 208 is a type of pointing input device. Display 207 and mouse 208 together constitute a type of user computer system interface.

Telecommunications hardware 220 may include a modem, PSTN interface circuitry, or T1 connection interface circuitry, for example. Telecommunication hardware 220 could also include a wireless transceiver for satellite communication.

Browser program 215 receives HTML files containing calendar for display, from server 100, via the global Internet and telecommunications hardware 220. User 201 may select a calendar entry for editing or deletion depending on the content of an HTML file displayed on display 207.

More specifically, browser program 215 displays contents of an HTML file to user 201 via display 207. User 201 views contents of the displayed file and, in response to the viewed contents, manipulates mouse input device 208 or keyboard 209. In other words, user 201 processes a light signal 160 from display 207 and, in response to contents of light signal 160, generates a type of calendar entry selection signal using device 208 or keyboard 209.

Process 305, in server 100 receives the selection signal (in the form of an HTTP GET request) from user 201 and, depending on the selection signal, changes or deletes a calendar entry record in database 317.

HTTP (Hyper Text Transport Protocol), is a standard World Wide Web client-server protocol used for the exchange of information between a browser and a Web server. The browser 172 sends the HTTP “GET” message containing a URL (Universal Resource Locator) assigned to server 100, “bureauflow.com” for example.

In summary CPU 362 executes process instructions in order to receive a message from a user computer system and, responsive to the message, send the stored set of tasks to the user computer system.

Throughout this Patent Application, certain processing may be depicted in serial, parallel, or other fashion, for ease of description. Actual hardware and software realizations, however, may be varied depending on desired optimizations apparent to one of ordinary skill in the art.

For example, although the calendar server 100 is in a separate system from the email server 15 in the embodiments exemplified above, the functions of the calendar server and the email server can be implemented on a common computer, or a common server.

For example, although the process 310 exemplified above for reading email is activated on a time basis, email reading could be activated by a user action, such as a login command. In the case of email reading activated by user action, the email reading could be performed in a separate process, and the processing of the HTTP request from the user computer system, to retrieve calendar information, could be asynchronous with the end of processing of the email reading.

The address input 249 of rule memory 240 shown in FIG. 2 can be implemented by software instructions and a database key value, as described in connection with step 40 of FIG. 13B. The database key value can be a user identification. Thus, system 100 selects the rule set for user system 2, rule set for user system 4, or rule set for user system 6.

The user identification can be derived from part of the “TO” field in the header of the current email message. See, for example, part 402 (“user4”) of the email message header shown in FIG. 4. In other words, system 100 can detect a user identification depending on a content of the “to” field of an email message header, without depending on a content of the email message body.

Alternatively, the user identification can be derived from data read from the body of the current email message. See, for example, part 401 (“Customer Cumber 38245”) of the email message header shown in FIG. 4. In other words, system 100 can detect a user identification depending on a content of an email message body (customer number 404), without depending on a content of the email message header.

The address input 209 of task memory 205 shown in FIG. 2 can be implemented by software instructions and a database key value, as described in connection with step 40 of FIG. 13B. Part of the database key value can be a user identification. The user identification can be derived from part of the “TO” field in the header of the current email message, without depending on a content of the email message body.

Alternatively, the user identification can be derived from data read from the body of the current email message, without depending on a content of the email message header.

In the case of activation of email reading in response to a user action, the user action need not specify which emails to select for processing. Instead, the selection of emails could be determined by those emails remaining in the inbox, or those emails in the inbox for which the database 317 indicates that processing has already been performed. In other words, the user action is not an important command that specifies which email message to process.

An Enrollment System

A user of user system 2 may establish an account with the server 100, by transmitting a server 100 user name (“smith352”) and server 100 user password (“password4624”), which are independent from the username (“pair@docketconnect.com”) and password (“frontroyal77”) that that server 100 uses to read email messages 1, 2, and 3 via email server 15. A user of user system 4 may establish an account with the server 100, by transmitting a server 100 user name (“jones947”) and server 100 user password (“turtle352zy”), which are independent from the username (“pair@docketconnect.com”) and password (“frontroyal77”) that that server 100 uses to read email messages 1, 2, and 3 via email server 15. A user of user system 6 may establish an account with the server 100, by transmitting a server 100 user name (“green123”) and server 100 user password (“dflj8384uw”), which are independent from the username (“pair@docketconnect.com”) and password (“frontroyal77”) that that server 100 uses to read email messages 1, 2, and 3 via email server 15.

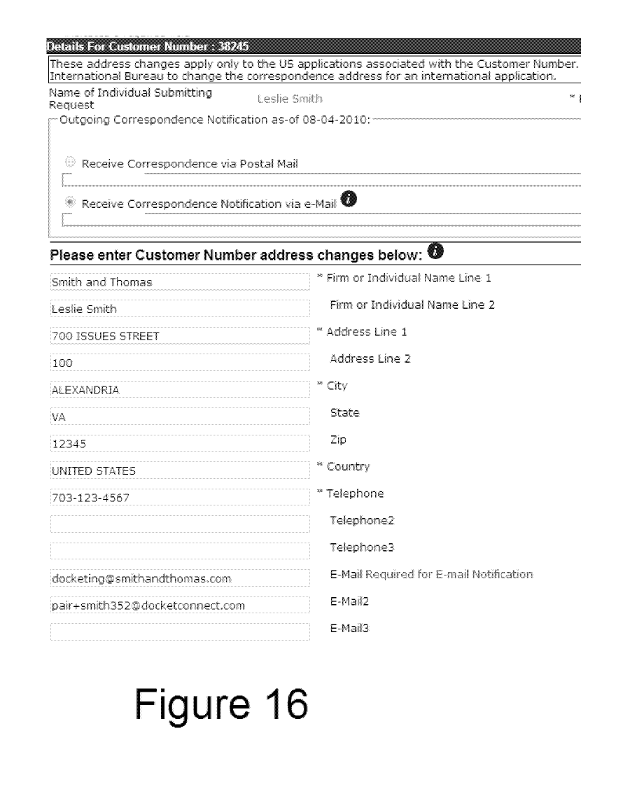

After a user establishes an account with server 100, the user can navigate to the site of notification server 10, and use the server 100 login ID to designate one of the correspondence emails. More specifically, as shown in FIG. 16, a user associated with system 2 is logged on to a server 10 account, associated with the customer number 38245, and designates an email address string, including an email account username (“pair”) appended to the user server 100 account username (“smith352”).

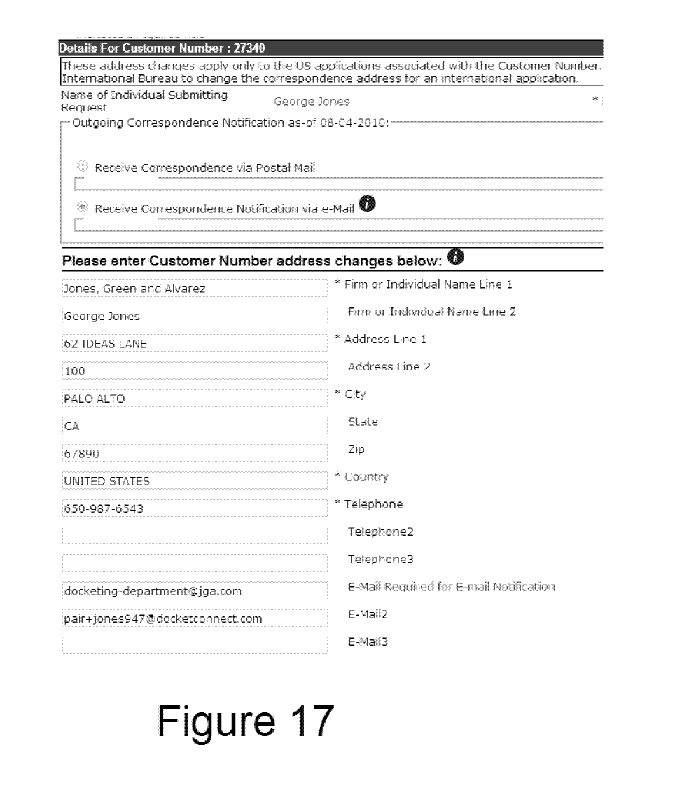

FIG. 17 shows a user associated with system 4 is logged on to a server 10 account, associated with the customer number 27340, and designates an email address string, including the email account username (“pair”) appended the user server 100 account username (“jones947”).

Email server 15 handles subaddressing, the practice of augmenting the local-part of an email address with other information. In this case, “+” forms a boundary between the user (“pair”) and another port of the address.

While system 2 is logged into server 100 user name “smith352”, system 2 sends a message 8 to the server 100, to cause server 100 server to reply with the set of stored tasks in message 9.

While system 4 is logged into server 100 user name “jones947”, system 4 sends a message 6 to the server 100, to cause server 100 server to reply with the set of stored tasks in message 7.

Additional advantages and modifications will readily occur to those skilled in the art. Benefits, other advantages, and solutions to problems have been described above with regard to specific examples. The benefits, advantages, solutions to problems, and any element(s) that may cause any benefit, advantage, or solution to occur or become more pronounced are not critical, required, or essential feature or element of any of the claims. The invention in its broader aspects is therefore not limited to the specific details, representative apparatus, and illustrative examples shown and described. Accordingly, departures may be made from such details without departing from the spirit or the scope of Applicants' general inventive concept. The invention is defined in the following claims. In general, the words “first,” “second,” etc., employed in the claims do not necessarily denote an order.

1. A system configured to manage a calendar, the system comprising:
first circuitry including a first set of computer instructions, activated without manual intervention, configured to
receive an electronic mail (email) message containing an event date and an event type,
search for the event type in a database and, if the event type is found, generate a set of tasks to be performed, each task having a respective date, one of the respective dates being different from the date of the event type, without manual intervention;
a memory configured to store the set of tasks; and
second circuitry including a second set of computer instructions, configured to subsequently receive a message from a computer system associated with a user and, responsive to the message, send the stored set of tasks to the computer system associated with a user.

2. The system of claim 1 wherein the circuitry configured to receive an email message receives the email message via a signal path that does not include the computer system associated with a user.

3. The system of claim 1 wherein the email message is not sent to the computer system associated with a user.

4. The system of claim 1 wherein the circuitry configured to search and generate is separated from the computer system associated with a user by more than 100 kilometers.

5. The system of claim 1 wherein the circuitry configured to receive receives the email message via a Mail User Agent.

6. The system of claim 1 wherein the circuitry configured to receive receives the email message via a Mail User Agent.

7. The system of claim 1 wherein the system is configured to send respective task sets to each of a plurality of computer system associated with a users, by sending a common password for email access to a Mail User Agent.

8. The system of claim 1 wherein the first circuitry is configured to receive a plurality of email messages, each corresponding to a respective set of tasks for a respective user computer, the plurality of email messages being accessed with a common user name and common password.

9. The system of claim 1 wherein the first circuitry uses a mailbox password to access the email message, no user of the computer system possesses the mailbox password, and the computer system associated with a user does not receive the mailbox password.

10. The system of claim 1 wherein the first circuitry dose not receive data from the second circuitry.

11. The system of claim 1 the first circuitry acts asynchronously relative to the second circuitry.

12. The system of claim 1 the second circuitry is activated a plurality of times per activation of the first circuitry.

13. The system of claim 1 wherein the memory includes a relational database configured to store automatically generated tasks and manually generated tasks.

14. The system of claim 1 further including circuitry configured to select email messages in the plurality of email messages, to process, without specification of the email message in a computer system associated with a user command.

15. The system of claim 1 wherein the first circuitry is activated responsive to a time scheduler, a period between activations being greater than 1 minute.

16. A method of managing a calendar, comprising:
receiving an electronic mail (email) message containing an event date and event type, by executing a first set of computer instructions;
searching for the event type in a database and if the event type is found, generating a set of tasks to be performed, each task having a respective date, one of the respective dates being different from the date of the event type, without manual intervention;
storing the set of tasks; and
subsequently, responsive to receiving a message from a computer system associated with a user, sending the stored set of tasks to the computer system associated with a user, by executing a second set of computer instructions.

17. A system configured to manage a calendar, the system comprising:
means for receiving an electronic mail (email) message containing an event date and an event type;
means, activated by reception of the email by the means for receiving, for searching for the event type in a database and, if the event type is found, generating a set of tasks to be performed, each task having a respective date, one of the respective dates being different from the date of the event type, without manual intervention;
means for storing the set of tasks; and
means for receiving a message from a computer system associated with a user and, responsive to the message, sending the stored set of tasks to the computer system associated with a user.

18-28. (canceled)
